(19) United States
(12) Patent Application Publication
(10) Pub. No.: US 2005/0210846 A1
(43) Pub. Date: Sep. 29, 2005

(54) High flow air filtration system

(75) Inventors: Stuart T. Miyagishima, Upland, CA (US); Shahriar Nick Niakan, Anaheim Hills, CA (US); Saul Daniel Zambrano, Quartz Hill, CA (US); Christopher M. Barron, Riverside, CA (US)

Correspondence Address: SHIMOKAJI & ASSOCIATES, P.C., 8911 RESEARCH DRIVE, IRVINE, CA, 92618, US

(73) Assignee: Advanced Flow Engineering, Inc., Corona, CA (US)

(21) Appl. No.: 11/011,833

(22) Filed: Dec. 14, 2004

Related U.S. Application Data
(60) Provisional application No. 60/556,171, filed on Mar. 24, 2004.

(51) Int. Cl. B01D 46/00

(52) U.S. Cl. 55/498

(57) ABSTRACT

An apparatus for filtering air includes a filter housing having an end plate and an annular aperture defining the size and shape of the end plate; and a filter element having a lip at an open end and a base at a closed end. The lip seals the filter element to the filter housing and to an unmodified, stock air intake of a vehicle. The filter media comprises pleated natural fiber fabric supported between two structural mesh layers. The base has a mounting post attached to the base that fits into a mounting hole in the end plate of the filter housing to hold the filter element in the housing. The base matches the size and shape of the end plate. The base and annular aperture are sized to optimize the filter media and pleat spacing for achieving a required airflow and maximal effective area for filtration.

### CROSS-REFERENCE TO RELATED APPLICATIONS

This application claims the benefit of U.S. Provisional Patent Application No. 60/556,171, filed on Mar. 24, 2004.

### BACKGROUND OF THE INVENTION

This invention relates to high performance air filtration systems, in particular, to high performance air filtration systems, such as for use within the Ford F-Series pickup trucks with a V8-6.0 L turbo diesel engine.

The function of an air intake filter is to remove the particulate matter from the intake air, so that clean air is provided to the engine. The intake air stream flows from the influent, or “dirty,” side of the filter to the effluent, or “clean,” side of the filter, with the air filter extracting the unwanted particles via one or more filter media layers. Filter media are selected to trap particles exceeding a particular size, while remaining substantially permeable to airflow over an expected filter lifetime.

The features and filter design choices that lead to improvements in one of these parameters (e.g., particle entrapment, airflow permeability, and filter lifetime) can lead to declines in the other performance parameters. Thus, filter design involves trade-offs among features achieving high filter efficiency, and features achieving a high filter capacity and concomitant long filter lifetime.

As used herein, filter efficiency is the propensity of the filter media to trap, rather than pass, particulates. Filter capacity is typically defined according to a selected limiting pressure differential across the filter, typically resulting from loading by trapped particulates. Volumetric filter flow rate, or flow rate, is a measure of the volume of air that can be drawn into the filter having a particular effective filter area, efficiency, and capacity, at a particular point in the expected filter lifetime.

The choice of filter media that has a high filter efficiency (wherein the filter media removes a high percentage of the particulate material in the intake air) is important, because any particulate matter passing through the filter may harm the engine. For systems of equal efficiency, a longer filter lifetime typically is directly associated with higher capacity, because the more efficiently the filter medium removes particles from an air stream, the more rapidly that filter medium approaches the pressure differential indicating the end of the filter medium life. To extend filter lifetime, filter media can be pleated to provide greater filtering surface area.

The choice of air filter media that is permeable to airflow is important because the interposition of the filter into the intake air stream can impede the flow rate. This tends to decrease engine efficiency, horsepower, torque, and fuel economy. In applications demanding large volumes of filtered air, the ability to manipulate parameters such as air filter size, pleat depth, or both, is often constrained additionally by the physical environment in which the filter is operated (e.g., the space available for a filter of a given configuration within the engine compartment).

Some existing air filters have been designed to achieve high volumetric flow applications that provide a significantly improved filter flow rate. However, such designs may foster air turbulence at the filter intake, which is an undesirable quality that ultimately impairs airflow. Some existing filter designs employ abrupt topological transitions, such as a one-step ring, a ledge, an edge, or a peak, which tend to encourage the development of air eddies and to reduce airflow into the filter. When air eddies cause influent air to bypass regions for the filter media near these abrupt transitions, the effective area available for filtration is reduced.

Filters using pleated media often secure one or both ends of the pleated media to a filter housing in such a manner that the pleats are jammed together such that air does not flow in between the pleats. In this situation, the effective area available for filtration is reduced.

As can be seen, there is a need for an improved filtration apparatus for achieving high efficiency filtration. Furthermore, there is a need for an improved filtration apparatus for achieving high volumetric flow rate and maximum effective area available for filtration.

### SUMMARY OF THE INVENTION

In one aspect of the present invention, an apparatus for filtering air includes: a filter housing having an influent side with an annular aperture at the influent side; and a filter element that fits inside the filter housing. The filter element has a base held to the influent side and has a lip at an open end. The lip seals to the filter housing, and the annular aperture and the base are sized to ensure a pleat spacing of the filter media that is greater than the minimum sufficient distance for maximal filtration area.

In another aspect of the present invention, an apparatus for filtering air includes: a filter housing having an influent side with an end plate at the influent side; and a filter element having a base at a closed end and a lip at an open end. The filter element comprises natural fiber fabric supported between two structural mesh layers and fits inside the filter housing with the closed end at the influent side, the base in contact with the end plate and the lip sealing the filter element against the housing. The base is sized to provide required airflow to an engine.

In a further aspect of the present invention, an apparatus for filtering air includes a filter housing having an end plate defined by an annular aperture; and a filter media having a base. The base matches the size and shape of the end plate. The base and annular aperture are sized to optimize the filter media for achieving maximal airflow and maximal effective area for filtration.

In still a further aspect of the present invention, an apparatus for filtering air includes a filter housing having an end plate and an annular aperture defining the size and shape of the end plate; and a filter element having a lip at an open end, a base at a closed end, and a cavity. The lip seals the filter element to the filter housing. The filter media comprises natural fiber fabric supported between two structural mesh layers. The base has a mounting post attached to the base for insertion into a mounting hole in the end plate of the filter housing. The base matches the size and shape of the end plate. The base and annular aperture are sized to optimize the filter media for achieving a required airflow and maximal effective area for filtration.

In yet a further aspect of the present invention, an apparatus for filtering intake air for an automobile includes an air intake conduit and a filter housing connected to the air intake conduit at an influent side of the filter housing, and having annular aperture surrounding an end plate. The apparatus also includes a filter element having a lip at an open end, a base, and a cavity. The base has a mounting post attached in the middle of the base for insertion into a mounting hole in the end plate of the filter housing. An air outlet conduit is connected to an effluent side of the filter housing and sealed to the filter housing and the filter element by the lip of the filter element. The air intake conduit is in fluid communication with the filter media and ambient air flows from the air intake conduit through the annular aperture, through the filter media and into the cavity. The air outlet conduit is in fluid communication with the filter media and filtered intake air flows from the cavity into the air outlet conduit. The filter media comprises natural fiber fabric supported between two structural mesh layers. The natural fiber fabric is oil-wetted using an efficacious amount of oil. The base and annular aperture are sized to optimize the filter element for achieving a required airflow and maximal effective area for filtration.

In still a further aspect of the present invention, a method of filtering airborne particulates from ambient air includes steps of: optimally sizing an annular aperture so that a required airflow is achieved when passing ambient air through the annular aperture; and spacing pleats of a pleated material of a filter media at no less than a minimum distance required for achieving maximal net filtration area when passing the ambient air through the filter media.

These and other features, aspects and advantages of the present invention will become better understood with reference to the following drawings, description and claims.

### BRIEF DESCRIPTION OF THE DRAWINGS

FIG. 1 is a plan view of an apparatus for filtering air, according to an embodiment of the present invention;

FIG. 2 is a perspective view from the influent side of an apparatus for filtering air, according to an embodiment of the present invention;

FIG. 3 is a perspective view from the effluent side of an apparatus for filtering air, according to an embodiment of the present invention;

FIG. 4 is an exploded view of the apparatus for filtering air of FIG. 2;

FIG. 5 is a perspective view from the influent side of an apparatus for filtering air, according to another embodiment of the present invention;

FIG. 6 is an exploded view of the apparatus for filtering air of FIG. 5;

FIG. 7A is a cross-sectional view of a multilayered filter media, according to an embodiment of the present invention;

FIG. 7B is a perspective view of a pleated filter media, according to an embodiment of the present invention; and

FIG. 8 is a flow chart of a method of filtering ambient air including airborne particulates.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides an air filtration system for the intake portion of an internal combustion engine (such as found in an automobile and, in particular, Ford F-Series pickup trucks with a V8-6.0 L turbo diesel engine).

An embodiment of the present invention may be distinguished from the prior art in its overall configuration, in which a pleated filter media of substantially conical form is placed with its air permeable wall divergent relative to the direction of airflow, with the narrow end of the conical form upstream and closed off by a disk-like base so that air passes from the outside of the cone to the inside and exits at the wider end of the conical form downstream. The base may be used for convenient mounting to a housing, unlike prior art filters that mount a conical-shaped media at the wider end upstream and rely on flow deflectors inside the cone at the narrow end downstream to help pass air from the inside of the cone to the outside. The base size also may be optimized to ensure proper pleat spacing—one of a number of parameters required for achieving maximal airflow and maximal effective area for filtration—at the narrow as well as the wide end of the cone, which concern appears to have been overlooked in the prior art.

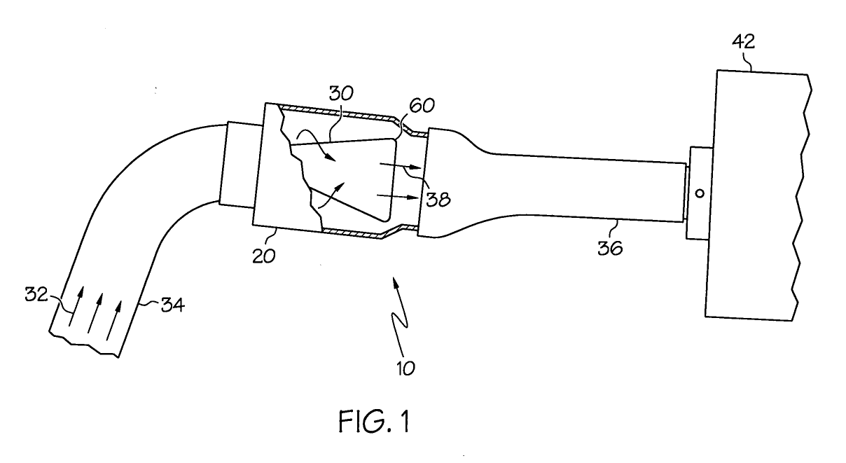

In FIG. 1, an apparatus 10 for filtering air is shown to have a filter housing 20. The filter housing 20 may be comprised of metal, such as cold rolled steel (painted or powder coated) or stainless steel. Housing 20 may be configured to interface with and be held in place to existing stock air intake ducting—such as air intake conduit 34 and air outlet cylinder 36—without modification of the stock ducting of the vehicle, which, for example, may be a Ford F-Series pickup truck with a V8-6.0 L turbo diesel engine. For example, housing 20 may be dimensioned to fit in the same location and may have clamps and mounting fixtures that mimic the clamps and mounting fixtures of original equipment manufacturer (OEM) air filters that are to be replaced by apparatus 10.

In operation, ambient air 32 may pass through air intake conduit 34 for filtration with conical shaped filter element 30 passing, as indicated by the arrows in the figure, from outside the conical shaped filter element 30 to inside and exiting at the wider open end 60. Filtered intake air 38 may then pass through an air outlet cylinder 36 and then be directed to each cylinder of an internal combustion engine 42. “Conical shaped” is here used to mean a tapered or generally conical shaped surface not restricted to having only a circular cross section, but which may, for example, have an oval or even rectangular shaped cross section.

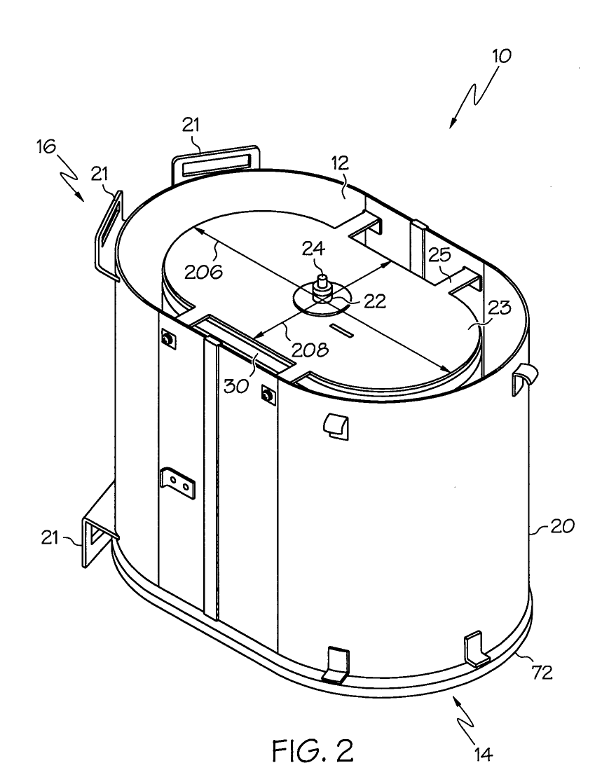

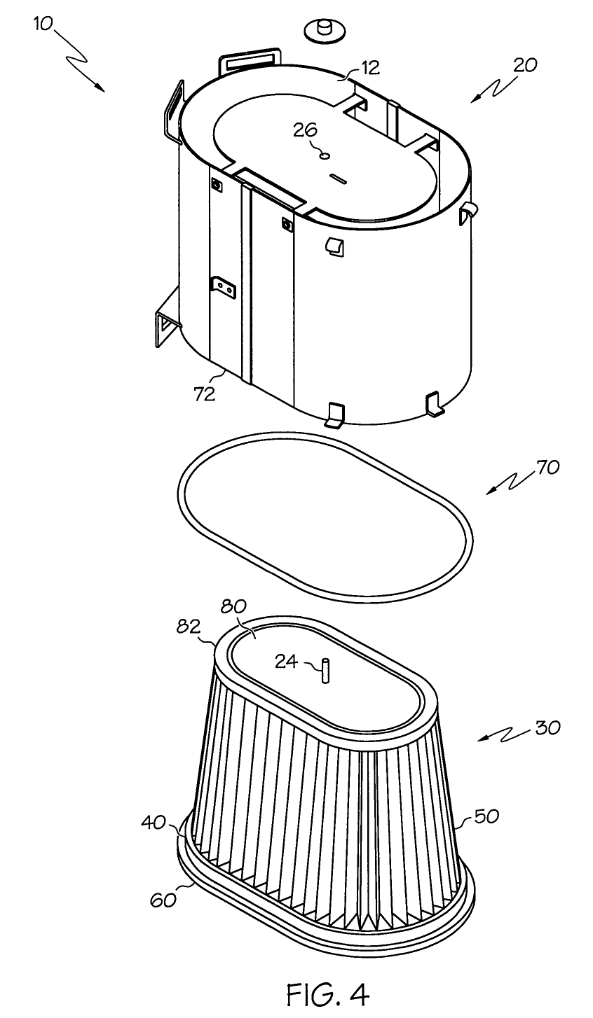

As shown in FIG. 2, the filter housing 20 may have a generally cylindrical shape with, for example, an oval or “racetrack” shaped cross section. Filter housing 20 may include mounting fixtures 21 that may be compatible with or even mimic stock mounting fixtures on an OEM housing or filter cartridge, for easy and convenient installation of apparatus 10. The filter housing 20 may include an annular aperture 12 at the influent side 16 of the filter housing 20. Annular aperture 12 may be situated between the outside of housing 20 and an end plate 23. End plate 23 may be attached to housing 20 via bridges 25. A mounting hole 26 (more clearly seen in FIG. 4) in the middle of end plate 23 allows mounting post 24, attached to filter element 30, to protrude through end plate 23 so that a nut 22 may secure the filter element 30 to the filter housing 20 by screwing the nut down firmly onto mounting post 24.

Annular aperture 12 defines the edge of end plate 23 and, thus, the size and shape of end plate 23. The size and shape of end plate 23 may match that of base 80 (shown in FIG. 4) of filter element 30 and may be similar to the cross section shape of housing 20, which may be, for example, an oval or “racetrack” shape. The oval shape of end plate 23 (and similarly for filter element 30 and housing 20) may be bounded in dimension by a major axis 206 (denoted “a” in the equation below) and a minor axis 208 (denoted “b” in the equation below). The term “eccentricity” may be defined as a dimensionless value that describes the relative roundness of a shape (such as end plate 23, housing 20, annular aperture 12, or base 80). In general, eccentricity (e) is related to the ratio of the minor axis 208 (b) of a shape to the major axis 206 (a) of the shape, by the relationship:
e=sqrt(1−(b²/a²))
Thus, when the eccentricity of a given shape has a value of about 0.0, the value of the minor axis b is nearly equal to the value of the major axis a, and the shape is essentially round. As the eccentricity of the shape increases towards a value close to 1.0, b becomes much less than a and the shape becomes increasingly elongated. Open end 60 of filter element 30 may have an eccentricity less than 1.0, often having an eccentricity of about 0.75. The base 80 of filter element 30 may have an eccentricity less than 1.0, often having an eccentricity of about 0.84. Annular aperture 12 may be designed to be large enough (e.g., about 1.0 inch in thickness) so that enough air flows through the aperture 12 to provide enhanced engine performance. Conversely, annular aperture 12 may be designed to be small enough that end plate 23 and matching filter base 80 can be large enough to maximize the net effective area of filter element 30 available for filtration. Housing 20 may also include a rim 72 at effluent side 14 of the filter housing 20, as shown in FIG. 2. Rim 72 may be used to seal housing 20 to filter media 30 at lip 40.

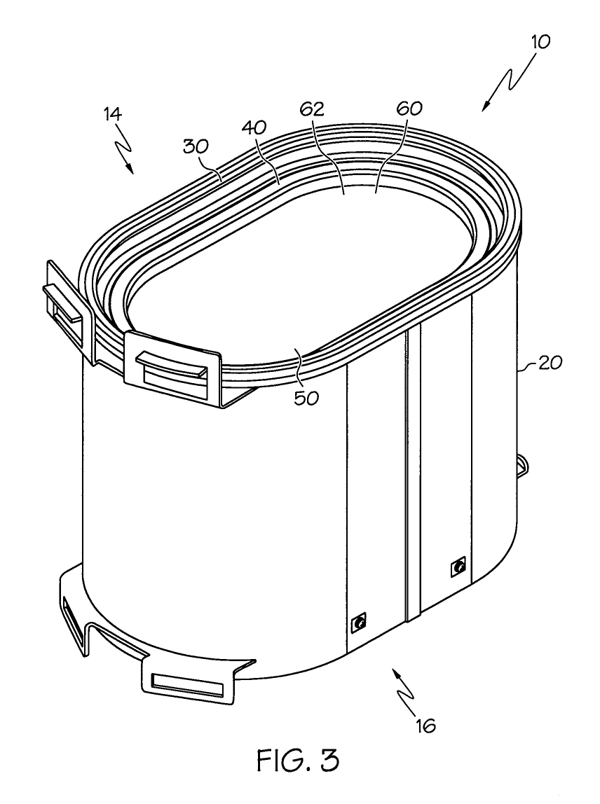

An embodiment of the present invention may be further understood in reference to FIG. 3, which is a view from the effluent side of apparatus 10. The filter element 30 may mate with the filter housing 20. A lip 40 of filter element 30 may surround an open end 60 of filter element 30 while the body 50 of filter element 30 may be enclosed within the filter housing 20. A cavity 62 of filter element 30 may be enclosed within the body 50.

In more specifically describing the present invention, and as can be appreciated from FIG. 4, the present invention provides an apparatus 10 for filtering air. The filter element 30 may have a conical shape, with a closed end 82 and an open end 60. Base 80 may be situated at the closed end 82 of the filter element 30. The base 80 may comprise one of urethane and polyurethane, for example.

The mounting post 24 may be situated on the top of the base 80 and centrally located. The mounting post 24 may be attached to the base 80 (for example, by molding) for insertion into mounting hole 26. The mounting hole 26 may be situated at the influent side 14 of the filter housing 20 to secure the filter element 30 to the filter housing 20, which may facilitate installation of apparatus 10 into a vehicle. A protective ring 70 may cover a rim 72 of filter housing 20. Lip 40 may be in contact with the protective ring 70, which may protect lip 40 from rim 72 of the filter housing 20 and which also may increase the effectiveness of the seal with lip 40 between housing 20 and filter element 30. Lip 40 may comprise one of urethane and polyurethane, for example, the resilience of which may aid in forming a seal between housing 20, filter element 30, and air outlet conduit 36 that is maintainable over long periods of time. Other materials—such as rubber or plastisol—tend to deform and harden over time so that the seal of filter element 30 becomes loose, losing effectiveness. Repeated tightening of such seal eventually destroys any effectiveness of the rubber for sealing.

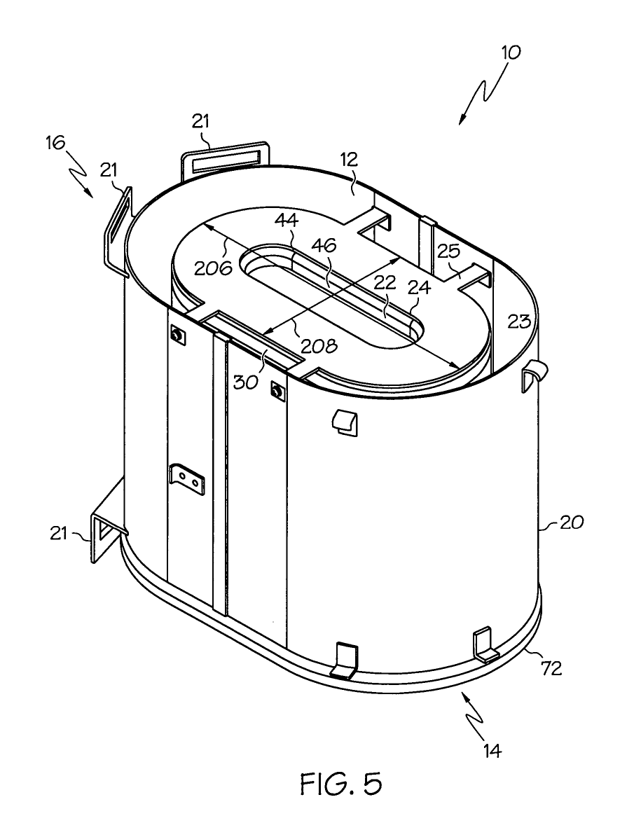

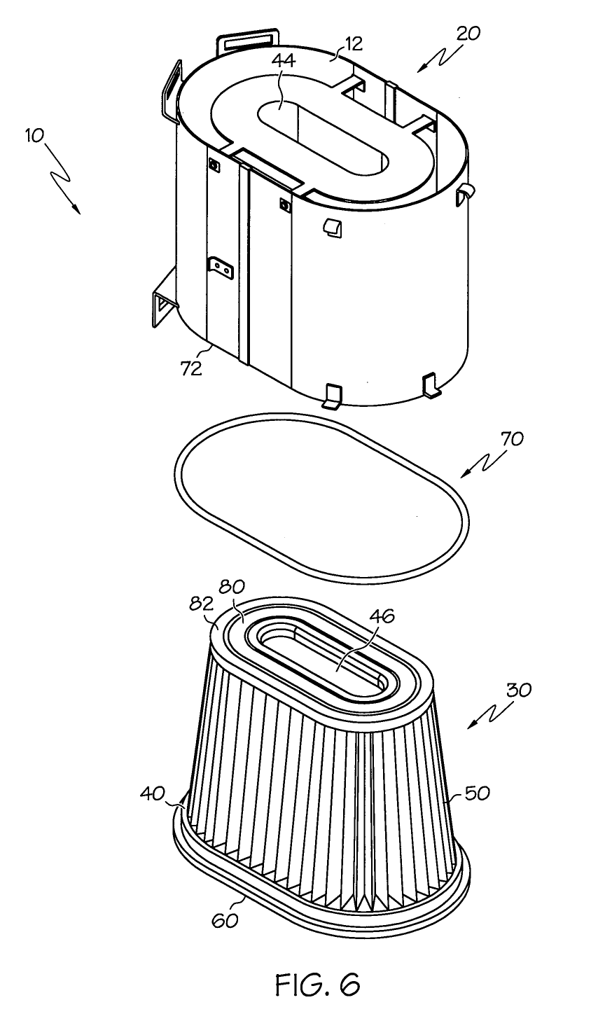

An alternate embodiment of the present invention is shown in FIG. 5. The filter housing 12 may be configured similarly as described above regarding FIG. 2. However, an inner aperture 44 may be present in the end plate 23 and a filter element aperture 46 may be present in the filter element 30. Using the inner aperture 44 and the filter element aperture 46 may be beneficial to increase the available area for filtration. Optionally, the inner aperture 44 and the filter element aperture 46 may be aligned for direct air flow. FIG. 6 shows an exploded view of the apparatus for filtering air 10 from FIG. 5.

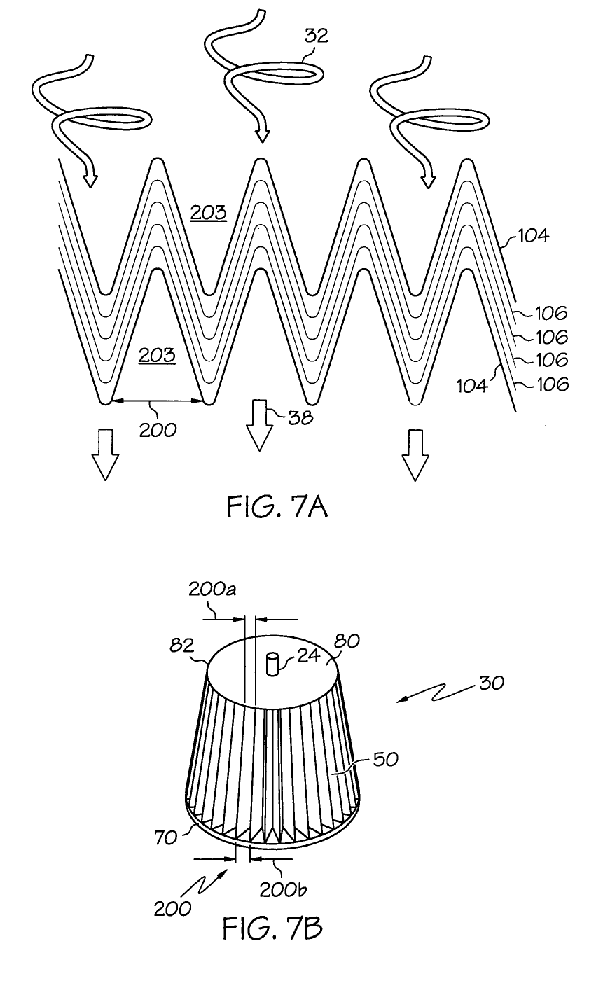

As shown in FIG. 7A, the body 50 of the filter element 30 may comprise a natural fiber fabric 106 (such as cotton mesh fabric) and may be supported between two structural mesh layers 104. The body 50 of the filter element 30 may be cleaned, such as by rinsing, for reuse instead of disposing of the filter element 30. Several layers of natural fiber fabric 106 may be sandwiched between two structural mesh layers 104. The structural mesh layers 104 may be comprised of epoxy-coated aluminum or steel. The natural fiber fabric 106 may be pleated and the structural mesh layers 104 may be co-pleated with the natural fiber fabric 106. The natural fiber fabric 106 may be oleophilic cotton mesh. The natural fiber fabric 106 may be oil-wetted using an efficacious amount of oil for increasing airborne particle trapping. The distance 200 between pleats (“pleat spacing”) should be sufficient to provide for ambient air 32 to pass through natural fiber fabric 106, becoming filtered intake air 38, in sufficient volume to supply requirements of internal combustion engine 42. The minimum sufficient distance 200 for required airflow and maximal filtration area may vary depending on engine 42, but it is evident from FIG. 7A that distance 200 cannot become less than the thickness 201 of material 106 without closing off areas 203 between the pleats, i.e., without diminishing the net effective area available of filter element 30 for filtration. If the net effective area available for filtration is diminished, then the amount of air flow across the filter element 30 decreases. Decreased air flow would mean less effective filtration to remove airborne particulates from ambient air 32.

As shown in FIG. 7B, the pleat distance 200 may vary. Pleat distance 200a at the closed end 82 of the filter element 30 may be smaller than pleat distance 200b near the lip 40 at open end 60 of the filter element 30. The base 80 may be large enough—and concomitantly, as described above, annular aperture 12 may be thin enough—so that base 80 allows for distance 200a to be greater than the minimum sufficient distance 200 for required airflow and maximal filtration area. The base 80 may hold the pleated body 50 in a position such that the pleats are maintained in an open position, i.e., with distance 200a greater than the thickness 201 of material 106 and not closing off areas 203 between the pleats.

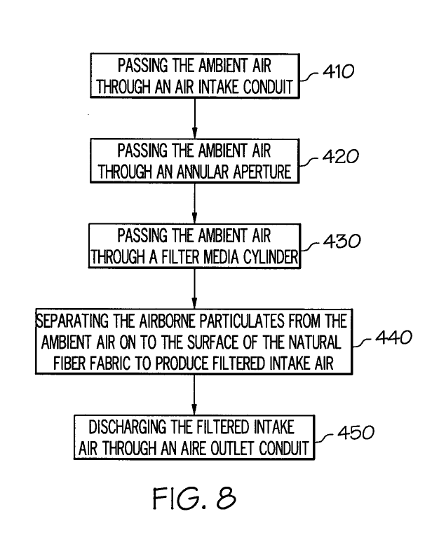

In FIG. 8, a method 400 for filtering ambient air including airborne particulates—such as ambient air 32—may comprise a step 410 of passing the ambient air through an air intake conduit. The air intake conduit may be an unmodified original equipment air duct—such as air intake conduit 34.

Thereafter, a step 420 may comprise passing the ambient air 32 through an annular aperture 12 in a housing 20 that attaches in the location of an OEM air filter between stock air ducts—such as air intake conduit 34 and air outlet conduit 36—without modifications to the stock air ducts. Step 420 may include passing an optimal amount of airflow through annular aperture 12 in accordance with the size and thickness of annular aperture 12.

Next, step 430 may comprise passing the ambient air 32 through a filter media 30 so that ambient air 32 is passed between pleats held at a minimum sufficient distance 200 for good airflow and maximal filtration area, past a base 80, through a natural fiber fabric 106 supported between two structural mesh layers 104, into a cavity 62 sealed to a housing 20 and air outlet conduit 36 by a lip 40.

Thereafter, a step 440 may comprise separating the airborne particulates from the ambient air 32 onto the surface of the natural fiber fabric 106 to produce filtered intake air 38.

Step 450 may comprise discharging the filtered intake air 38 through an air outlet conduit 36 where it may be inhaled by an internal combustion engine 42.

It should be understood, of course, that the foregoing relates to exemplary embodiments of the invention and that modifications may be made without departing from the spirit and scope of the invention as set forth in the following claims.

1. An apparatus for filtering air, comprising:
a filter housing having an influent side with an annular aperture at the influent side; and
a filter element that fits inside the filter housing, the filter element having a base held to the influent side and having a lip at an open end, the lip sealing to the filter housing and wherein:
the annular aperture and the base are sized to ensure a pleat spacing of the filter media that is greater than the minimum sufficient distance for maximal filtration area.

2. The apparatus of claim 1, wherein the lip has an eccentricity of about 0.75.

3. The apparatus of claim 1, wherein the base has an eccentricity of about 0.84.

4. The apparatus of claim 1, wherein the base is situated at a closed end of the filter element cone.

5. The apparatus of claim 1, further comprising a protective ring in contact with the lip and the filter housing.

6. An apparatus for filtering air, comprising:
a filter housing having an influent side with an end plate at the influent side; and
a filter element having a base at a closed end, a lip at an open end, and wherein:
the filter element comprises natural fiber fabric supported between two structural mesh layers and fits inside the filter housing with the closed end at the influent side, the base in contact with the end plate and the lip sealing the filter element against the housing; and
the base is sized to provide required airflow to an engine.

7. The apparatus of claim 6, wherein the natural fiber fabric comprises cotton mesh fabric.

8. The apparatus of claim 6, wherein the natural fiber fabric is pleated and the pleats have spacing greater than a minimum sufficient distance for required airflow to an engine.

9. The apparatus of claim 6, wherein the natural fiber fabric is oil-wetted using an efficacious amount of oil.

10. The apparatus of claim 6, further comprising a protective ring in contact with the lip and covering a rim of the filter housing.

11. An apparatus for filtering air, comprising:
a filter housing having an end plate defined by an annular aperture; and
a filter element having a base, wherein:
the base matches the size and shape of the end plate;
the base and annular aperture are sized to optimize the filter media for achieving maximal airflow and maximal effective area for filtration.

12. The apparatus of claim 11, wherein the filter housing comprises cold rolled steel (painted or powder coated) or stainless steel.

13. The apparatus of claim 11, wherein the filter media comprises pleated material with a pleat distance greater than the thickness of the filter media material.

14. The apparatus of claim 11, wherein the base comprises one of urethane and polyurethane.

15. The apparatus of claim 11, wherein the base is situated at a closed end of the filter media.

16. The apparatus of claim 13, wherein the pleat distance at the closed end of the pleated filter media is greater than a minimum sufficient distance for required airflow to an engine.

17. The apparatus of claim 11, further comprising a lip of the filter element that seals the filter element to the filter housing.

18. The apparatus of claim 13, wherein the pleated material comprises natural fiber fabric and is supported between two structural mesh layers.

19. The apparatus of claim 18, wherein the two structural mesh layers are co-pleated with the natural fiber fabric.

20. The apparatus of claim 18, wherein the natural fiber fabric is oil-wetted using an efficacious amount of oil.

21. An apparatus for filtering air, comprising:
a filter housing having an end plate and an annular aperture defining the size and shape of the end plate; and
a filter element having a lip at an open end, and a base at a closed end, and a cavity; wherein:
the lip seals the filter element to the housing;
the filter element comprises natural fiber fabric supported between two structural mesh layers;
the base has a mounting post attached to the base for insertion into a mounting hole in the end plate of the filter housing;
the base matches the size and shape of the end plate; and
the base and annular aperture are sized to optimize the filter media for achieving a required airflow and maximal effective area for filtration.

22. The apparatus of claim 21, wherein the natural fiber fabric is pleated.

23. The apparatus of claim 22, wherein the two structural mesh layers are co-pleated with the natural fiber fabric.

24. The apparatus of claim 21, wherein the two structural mesh layers comprise epoxy-coated aluminum or steel.

25. The apparatus of claim 21, wherein the lip has an eccentricity of about 0.75.

26. The apparatus of claim 21, wherein the base has an eccentricity of about 0.84.

27. The apparatus of claim 22, wherein the base is situated at the closed end of the pleated filter element.

28. An apparatus for filtering intake air for an automobile, comprising:
an air intake conduit;
a filter housing connected to the air intake conduit at an influent side of the filter housing, and having annular aperture surrounding an end plate;
a filter element having a lip at an open end, a base, and a cavity;
the base having a mounting post attached in the middle of the base for insertion into a mounting hole in the end plate of the filter housing; and
an air outlet conduit connected to an effluent side of the filter housing and sealed to the filter housing and the filter element by the lip of the filter element;
wherein the air intake conduit is in fluid communication with the filter element and ambient air flows from the air intake conduit through the annular aperture, through the filter element and into the cavity;
wherein the air outlet conduit is in fluid communication with the filter element and filtered intake air flows from the cavity into the air outlet conduit;
wherein the filter media comprises natural fiber fabric supported between two structural mesh layers;
wherein the natural fiber fabric is oil-wetted using an efficacious amount of oil; and
wherein the base and annular aperture are sized to optimize the filter media for achieving a required airflow and maximal effective area for filtration.

29. The apparatus of claim 28, wherein the natural fiber fabric comprises cotton mesh fabric.

30. The apparatus of claim 28, wherein the lip and the base both have an oval shape.

31. The apparatus of claim 28, wherein the lip comprises polyurethane material.

32. The apparatus of claim 28, wherein the lip has an eccentricity less than 1.0.

33. The apparatus of claim 32, wherein the lip has an eccentricity of about 0.75.

34. The apparatus of claim 28, wherein the base has an eccentricity less than 1.0.

35. The apparatus of claim 34, wherein the base has an eccentricity of about 0.84.

36. The apparatus of claim 28, wherein the two structural mesh layers are co-pleated with the natural fiber fabric.

37. A method of filtering airborne particulates from ambient air, comprising:
optimally sizing an annular aperture so that a required airflow is achieved when passing ambient air through the annular aperture; and
spacing pleats of a pleated material of a filter media at no less than a minimum distance required for achieving maximal net filtration area when passing the ambient air through the filter media.

38. The method of claim 37, further comprising a step of sealing the filter element within a filter housing using a resilient lip at an open end of the filter element.

39. The method of claim 37, further comprising a step of passing the ambient air through an air intake conduit.

40. The method of claim 37, further comprising a step of separating the airborne particulates from the ambient air onto the surface of a natural fiber fabric to produce filtered intake air.

41. The method of claim 37, further comprising a step of discharging the filtered intake air through an air outlet conduit.
